(19) United States
(12) Patent Application Publication
(10) Pub. No.: US 2018/0165582 A1
(43) Pub. Date: Jun. 14, 2018

(54) SYSTEMS AND METHODS FOR DETERMINING SENTIMENTS IN CONVERSATIONS IN A CHAT APPLICATION

(71) Applicant: Facebook, Inc., Menlo Park, CA (US)

(72) Inventor: Meeyoung Cha, Redwood City, CA (US)

(21) Appl. No.: 15/373,415

(22) Filed: Dec. 8, 2016

(51) Int. Cl. G06N 5/04; G06N 99/00; H04L 12/58

(52) U.S. Cl. CPC G06N 5/04; H04L 51/046; G06N 99/005

(57) ABSTRACT

Systems, methods, and non-transitory computer readable media can obtain a conversation of a user in a chat application associated with a system, where the conversation includes one or more utterances by the user. An analysis of the one or more utterances by the user can be performed. A sentiment associated with the conversation can be determined based on a machine learning model, wherein the machine learning model is trained based on a plurality of features including demographic information associated with users.

### FIELD OF THE INVENTION

The present technology relates to the field of social networks. More particularly, the present technology relates to techniques for determining sentiments associated with conversations.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can post, share, and access various content items, such as status updates, images, videos, articles, and links, via the social networking system.

A social networking system can provide a chat or messaging application. A chat application can be used for various types of communications associated with the social networking system. The social networking system can provide pages for various entities. Pages can be dedicated locations on the social networking system to reflect a presence of entities on the social networking system. Examples of entities can include companies, businesses, brands, products, artists, public figures, entertainment, individuals, and other types of entities.

### SUMMARY

Various embodiments of the present disclosure can include systems, methods, and non-transitory computer readable media configured to obtain a conversation of a user in a chat application associated with a system, where the conversation includes one or more utterances by the user. An analysis of the one or more utterances by the user can be performed. A sentiment associated with the conversation can be determined based on a machine learning model, wherein the machine learning model is trained based on a plurality of features including demographic information associated with users.

In some embodiments, the system is a social networking system, and the conversation is between the user and an agent associated with a page of an entity in the social networking system.

In certain embodiments, the machine learning model can be trained based on the plurality of features, wherein the plurality of features further include one or more of: attributes associated with conversations, attributes associated with post history of users, or attributes associated with page history of users.

In an embodiment, the machine learning model provides one or more of: a sentiment score associated with the conversation or a sentiment label associated with the conversation.

In some embodiments, the sentiment label is indicative of a rating on a rating scale.

In certain embodiments, the sentiment associated with the conversation is determined in or near real time.

In an embodiment, the performing the analysis of the one or more utterances by the user includes performing a textual analysis of an utterance by the user.

In some embodiments, the performing the analysis of the one or more utterances by the user includes determining a sentiment associated with one or more of: an emoticon, an emoji, or an indicator relating to text style.

In certain embodiments, the sentiment associated with the conversation is determined based at least in part on the analysis of the one or more utterances by the user.

In an embodiment, an updated sentiment associated with the conversation can be determined based on the machine learning model at a time subsequent to a time at which the sentiment is determined, and a change between the sentiment and the updated sentiment can be detected.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example sentiment score module configured to determine sentiments associated with conversations, according to an embodiment of the present disclosure.

FIG. 2A illustrates an example sentiment training module configured to train a machine learning model based on data relating to sentiments, according to an embodiment of the present disclosure.

FIG. 2B illustrates an example sentiment evaluation module configured to determine sentiments associated with conversations, according to an embodiment of the present disclosure.

FIG. 3 illustrates an example scenario for determining sentiments associated with conversations, according to an embodiment of the present disclosure.

FIG. 4 illustrates an example first method for determining sentiments associated with conversations, according to an embodiment of the present disclosure.

FIG. 5 illustrates an example second method for determining sentiments associated with conversations, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Systems and Methods for Determining Sentiments in Conversations in a Chat Application

People use computing devices (or systems) for a wide variety of purposes. Computing devices can provide different kinds of functionality. Users can utilize their computing devices to produce information, access information, and share information. In some cases, users can utilize computing devices to access a conventional social networking system (e.g., a social networking service, a social network, etc.). A social networking system may provide user profiles or entity pages for various users and entities through which the users and the entities may add connections (e.g., friends), publish content items, or provide products or services, to name some examples. In some instances, a user on a social networking system can be an individual person and an entity on the social networking system can be a business or other type of organization. An entity can be represented through a dedicated page on the social networking system that is managed by one or more agents or administrators. Agents associated with an entity can interact and communicate with potential or actual customers of the entity.

Conventional approaches specifically arising in the realm of computer technology can determine sentiments associated with customer service conversations between users and agents of entities in a chat or messaging application. A conversation can include one or more utterances. An utterance can refer to a unit of conversation by a user or an agent. An utterance or a conversation as a whole can reflect one or more sentiments, such as satisfaction, frustration, etc. Conventional approaches can determine sentiment scores associated with utterances, for example, based on textual analysis. Conventional approaches may determine sentiments associated with conversations, for example, based on sentiment scores associated with utterances. However, sentiments determined under conventional approaches may not reflect various attributes associated with a user in a conversation. For example, a sentiment many not reflect demographic characteristics of the user.

An improved approach rooted in computer technology can overcome the foregoing and other disadvantages associated with conventional approaches specifically arising in the realm of computer technology. Based on computer technology, the disclosed technology can determine sentiments associated with conversations in a chat or messaging application based on attributes associated with users. A social networking system can provide a chat or messaging application. A chat application can be used for various types of communications associated with the social networking system. As an example, users can participate in a conversation within the chat application, such as a chat, with agents of entities that are represented on the social networking system, for example, by pages. The social networking system can provide pages for various entities. Pages can be dedicated locations on the social networking system to reflect a presence of entities on the social networking system. Examples of entities can include companies, businesses, brands, products, artists, public figures, entertainment, individuals, and other types of entities. Users can engage in a chat with agents of an entity through the entity's page. For example, a user who is a customer of a business can chat with an agent of the business through the chat application. In many cases, there may not be direct feedback from users regarding their levels of satisfaction with conversations with agents, but it may be helpful to know whether conversations are positive or negative.

Accordingly, the disclosed technology can determine a sentiment associated with a conversation between a user and an agent of an entity based on various factors. Examples of factors can include sentiment scores associated with utterances of the user in the conversation, previous posts by the user on the page of the entity, demographic characteristics associated with the user, and post history of the user on the social networking system. A conversation between the user and the agent can include one or more utterances by the user and one or more utterances by the agent. The disclosed technology can generate a sentiment score for each utterance of the user. Sentiment scores can dynamically change over the course of a conversation. A sentiment score for an utterance can be determined based on textual and other information associated with the utterance. The user may have posted on the page of the entity prior to the conversation, and sentiments of the user's previous page posts can also be used in determining sentiments associated with the conversation. In addition, demographic characteristics associated with the user (e.g., age, gender, etc.) can be used in determining sentiments associated with the conversation. For example, the same word can convey a different sentiment for different age groups or genders. Further, sentiments associated with the user's posts on the social networking system can be considered in determining sentiments associated with the user. For example, words used in a conversation of a particular user may generate a negative sentiment score, but the particular user may generally use such words in the user's posts. Therefore, the negative sentiment score can be weighted based on the user's post history. Based on the various factors, the disclosed technology can generate an overall sentiment score associated with the conversation. For example, a machine learning model can be trained based on features relating to the various factors, and the trained machine learning model can generate the overall sentiment score for the conversation. The overall sentiment score can be converted to a rating on a rating scale (e.g., a 5-point scale). The rating or a corresponding label can be assigned to the conversation. A rating on a rating scale and/or a label corresponding to the rating can be referred to as a “sentiment label.” In this manner, the disclosed technology can determine sentiments associated with conversations. Details relating to the disclosed technology are explained below.

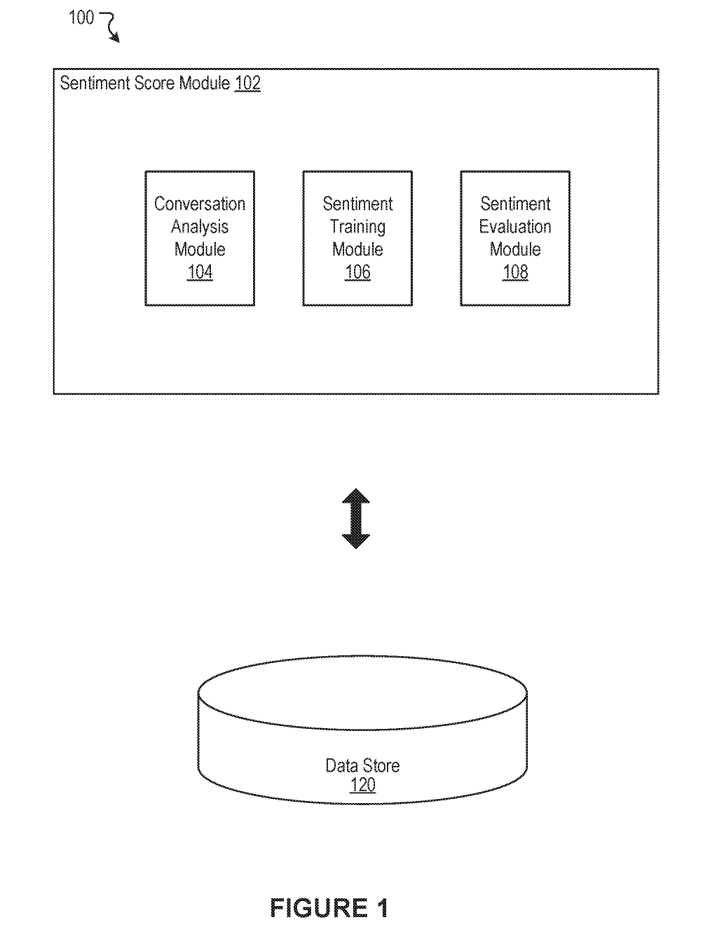

FIG. 1 illustrates an example system 100 including an example sentiment score module 102 configured to determine sentiments associated with conversations, according to an embodiment of the present disclosure. The sentiment score module 102 can include a conversation analysis module 104, a sentiment training module 106, and a sentiment evaluation module 108. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the sentiment score module 102 can be implemented in any suitable combinations. For illustrative purposes, the disclosed technology is described in connection with conversations in a chat application and a social networking system, but the disclosed technology can apply to any type of content as well as any type of application or system. In addition, sentiments associated with conversations are explained in connection with sentiment scores and/or sentiment labels for illustrative purposes, and the disclosed technology can provide sentiments associated with conversations in any format.

The conversation analysis module 104 can determine sentiment scores associated with utterances in a conversation. For example, the conversation analysis module 104 can perform textual analysis of an utterance. An utterance can indicate a unit of conversation in a chat. In some embodiments, utterances can be separated by a special character or a control character, such as enter or carriage return. For example, a user can type text and press an enter button, and the text typed before the press of the enter button can constitute an utterance. An utterance can be logged with a timestamp, a speaker, text content, etc. Words included in an utterance can be analyzed to determine a sentiment score associated with the utterance. For example, a dictionary listing words and associated sentiment scores can be used to assign a sentiment score for a word or a group of words in the utterance. A dictionary can specify a sentiment score for a word or a group of words. In some cases, a word may not be indicative of a sentiment on its own but may be indicative of a sentiment in combination with one or more other words. In certain embodiments, a higher score can indicate a positive sentiment, and a lower score can indicate a negative sentiment. In other embodiments, a positive score can indicate a positive sentiment, and a negative score can indicate a negative sentiment. A sentiment score for an utterance can be generated based on sentiment scores for words or groups of words in the utterance. For example, sentiment scores for words or groups of words included in the utterance can be averaged. As another example, a ratio of positive scores to negative scores can be considered. In some embodiments, sentiments scores can be determined only for utterances of users. In other embodiments, sentiments scores can be determined for utterances of both users and agents. In certain embodiments, a textual analysis tool and/or a sentiment analysis tool can be used to determine sentiment scores for utterances. All examples herein are provided for illustrative purposes, and there can be many variations and other possibilities.

The conversation analysis module 104 can also determine sentiments associated with emoticons, emojis, or other indicators included in or associated with utterances. In some cases, a user may include an emoticon or an emoji in an utterance, and the emoticon or the emoji can convey a sentiment. Accordingly, the conversation analysis module 104 can determine sentiments associated with emoticons or emojis included in an utterance. In some embodiments, an emoticon or an emoji can be categorized as positive, neutral, or negative. In other embodiments, an emoticon or an emoji can be associated with a score. An utterance can be associated with an indicator or a marker that can convey a sentiment. For example, an indicator or a marker that can convey a sentiment can relate to text style or appearance. As an example, typing in all capital letters can convey a negative sentiment, such as anger or frustration. In some embodiments, an indicator associated with an utterance can be categorized as positive, neutral, or negative. In other embodiments, an indicator associated with an utterance can be associated with a score. In certain embodiments, sentiments associated with the emoticons, emojis, or other indicators associated with utterances can be reflected in sentiment scores for utterances based on textual analysis. For example, scores for emoticons, emojis, or other indicators can be combined with sentiment scores for utterances based on textual analysis. In some embodiments, sentiments associated with emoticons, emojis, and other indicators can be determined for only utterances of users. In other embodiments, sentiments associated with emoticons, emojis, and other indicators can be determined for utterances of both users and agents. In certain embodiments, an analysis tool and/or a sentiment analysis tool can be used to determine sentiments associated with emoticons, emojis, or other indicators. All examples herein are provided for illustrative purposes, and there can be many variations and other possibilities.

The sentiment training module 106 can train a machine learning model to determine sentiments associated with conversations. For example, the sentiment training module 106 can train a machine learning model based on data relating to conversation between users and agents of entities. Functionality of the sentiment training module 106 is described in more detail herein.

The sentiment evaluation module 108 can apply a trained machine learning model to determine sentiments associated with conversations. For example, the sentiment evaluation module 108 can apply the trained machine learning model to a conversation between a user and an agent of an entity to output a sentiment score and/or a sentiment label associate with the conversation. Functionality of the sentiment evaluation module 108 is described in more detail herein.

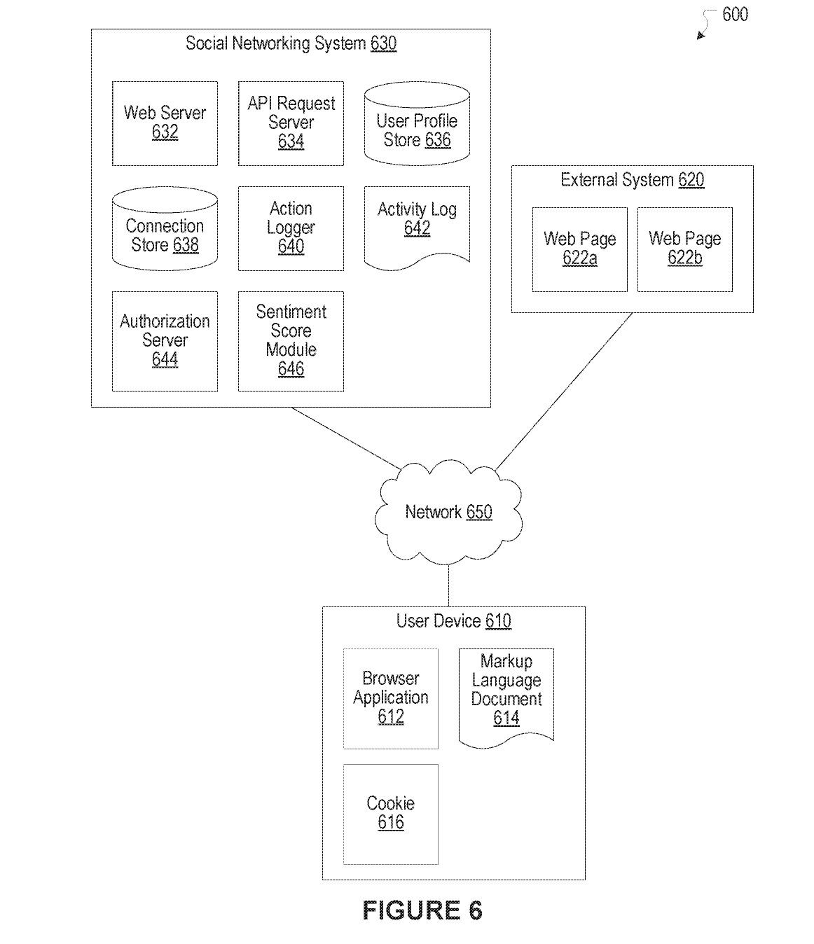

In some embodiments, the sentiment score module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the sentiment score module 102 can be, in part or in whole, implemented as software running on one or more computing devices or systems, such as on a server system or a client computing device. In some instances, the sentiment score module 102 can be, in part or in whole, implemented within or configured to operate in conjunction or be integrated with a social networking system (or service), such as a social networking system 630 of FIG. 6. Likewise, in some instances, the sentiment score module 102 can be, in part or in whole, implemented within or configured to operate in conjunction or be integrated with a client computing device, such as the user device 610 of FIG. 6. For example, the sentiment score module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the sentiment score module 102. The data maintained by the data store 120 can include, for example, information relating to machine learning models, conversations between users and agents of entities, sentiment scores, sentiment labels, user demographics, user posts in a social networking system, user posts on pages of entities, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the sentiment score module 102 can be configured to communicate and/or operate with the data store 120. In some embodiments, the data store 120 can be a data store within a client computing device. In some embodiments, the data store 120 can be a data store of a server system in communication with the client computing device.

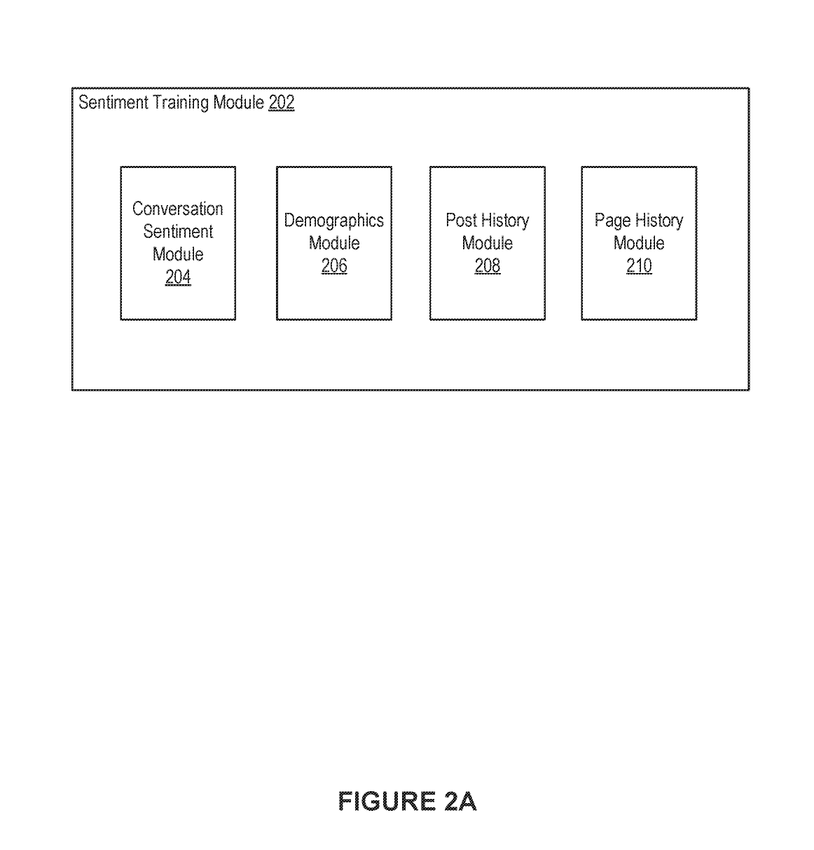

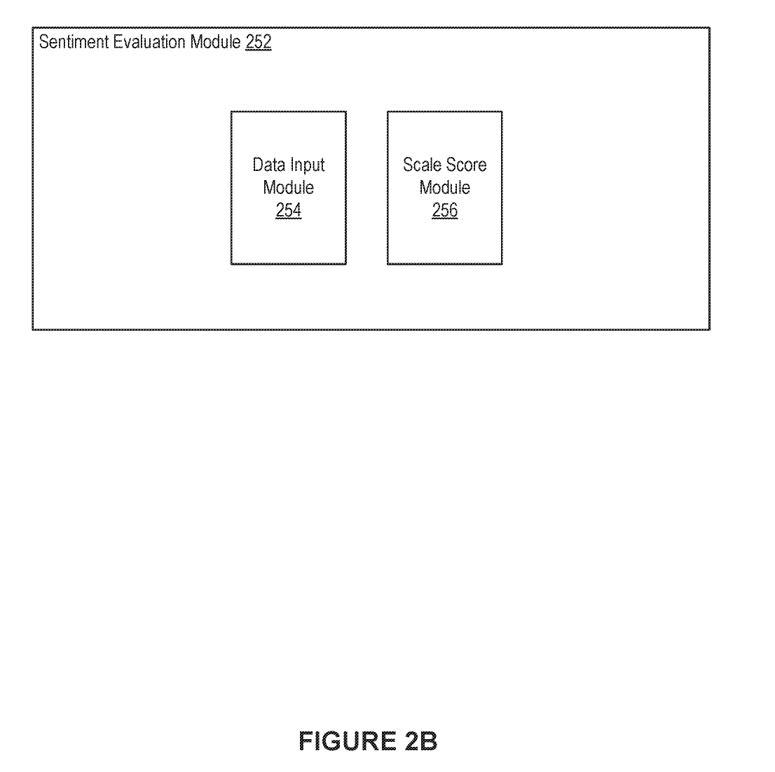

FIG. 2A illustrates an example sentiment training module 202 configured to train a machine learning model based on data relating to sentiments, according to an embodiment of the present disclosure. In some embodiments, the sentiment training module 106 of FIG. 1 can be implemented with the example sentiment training module 202. As shown in the example of FIG. 2, the example sentiment training module 202 can include a conversation sentiment module 204, a demographics module 206, a post history module 208, and a page history module 210.

The sentiment training module 202 can train a machine learning model based on training data relating to conversation between users and agents of entities. For example, the training data can include conversations between users and agents of entities, sentiment scores associated with utterances in the conversations, sentiment labels associated with the conversations, etc. Various features can be used in training the machine learning model. For example, features can include attributes associated with conversations, attributes associated with demographics of users, attributes associated with post history of users, attributes associated with page history of users, etc. Attributes associated with conversations, attributes associated with demographics, attributes associated with post history of users, and attributes associated with page history of users are explained further below. As an example, for each conversation included in the training data, the training data can include attributes associated with the conversation, attributes associated with demographic characteristics of a user associated with the conversation, attributes associated with post history of the user, and attributes associated with page history of the user. In some embodiments, the machine learning model can be a classifier. Many variations are possible, and features can be selected as appropriate to train the machine learning model.

The conversation sentiment module 204 can obtain data relating to attributes associated with conversations. Attributes associated with conversations can include a length of a conversation, sentiment scores for utterances of a conversation, words included in a conversation, lengths of words included in a conversation, a number of uppercase letters included in a conversation, a number of lowercase letters included in a conversation, etc. The length of a conversation can indicate an amount of time the conversation took. Sentiments scores for utterances of a conversation can indicate respective sentiment scores for utterances of a conversation. For example, the sentiment scores for utterances can be in the form of a sequence of scores. The sentiment scores for utterances can include sentiment scores determined by the conversation analysis module 104 as described above. The words included in a conversation can indicate one or more words included in the conversation. The lengths of words included in a conversation can indicate lengths of one or more words included in the conversation. The number of uppercase letters included in a conversation can indicate a total number of uppercase letters or characters in the conversation. The number of lowercase letters included in a conversation can indicate a total number of lowercase letters or characters in the conversation. In some embodiments, attributes associated with conversations can be considered for only utterances of users. In other embodiments, attributes associated with conversations can be considered for utterances of both users and agents. Many variations are possible, and attributes associated with conversations can be selected as appropriate.

The demographics module 206 can obtain data relating to attributes associated with demographics of users. Attributes associated with demographics of users can include an age, an age range, a gender, a location or geographical region, a number of connections, etc. Examples of a location or geographical region can include a country, a state, a city, a county, etc. Attributes associated with demographic characteristics of a user can be used to normalize sentiment scores associated with conversations of the user. Many variations are possible, and attributes associated with demographics can be selected as appropriate.

The post history module 208 can obtain data relating to attributes associated with post history of users. Attributes associated with post history of users can include sentiment scores associated with posts of users. Posts can include any type of content items created by users in a social networking system. For example, a user may post a content item in the user's profile or another user's profile. Sentiment scores for posts can be determined in a similar manner as sentiment scores for utterances. For example, textual analysis of a post can be performed. Words included in a post can be analyzed to determine a sentiment score associated with the post. In some embodiments, a textual analysis tool and/or a sentiment analysis tool can be used to determine sentiment scores for posts. Posts of a user in the social networking system can provide a sense of general sentiment of the user. Sentiment scores associated with posts of a user can be used to normalize sentiment scores associated with conversations of the user. In certain embodiments, attributes associated with post history of users can include an average value of sentiment scores for posts of a user. Attributes associated with post history of users can also include sentiments associated with status indicators. The social networking system may provide status indicators for users to express sentiments. For example, a status indicator can specify that a user is happy, sad, etc. Sentiments associated with status indicators can be determined. In some embodiments, a status indicator can be categorized as positive, neutral, or negative. In other embodiments, a status indicator can be associated with a score. Many variations are possible, and attributes associated with post history of users can be selected as appropriate.

The page history module 210 can obtain data relating to attributes associated with page history of users. Attributes associated with page history of users can include sentiment scores associated with posts of users on pages associated with conversations. For example, a user engaged in a conversation with an agent of an entity may have previously posted on the page. Posts of the user on the page can provide a sense of sentiment of the user toward the entity. Sentiment scores for posts of users on pages can be determined in a similar manner as sentiment scores for utterances. For example, textual analysis of a post can be performed. Words included in a post on a page can be analyzed to determine a sentiment score associated with the post. In some embodiments, a textual analysis tool and/or a sentiment analysis tool can be used to determine sentiment scores for posts on pages. In certain embodiments, attributes associated with post history of users can include an average value of sentiment scores for posts of a user on pages. Many variations are possible, and attributes associated with page history of users can be selected as appropriate.

The machine learning model can be retrained based on new or updated training data. For example, if information about new conversations becomes available, the sentiment training module 202 can train the machine learning model based on the information about new conversations. The sentiment training module 202 can refine the machine learning model in order to achieve desired results, for example, by retraining the machine learning model, adjusting features included in the machine learning model, etc. In some cases, users may provide feedback relating to sentiments associated with conversations. Feedback by users can be used to train or retrain the machine learning model for determining sentiments, for example, as a part of the training data.

FIG. 2B illustrates an example sentiment evaluation module 252 configured to determine sentiments associated with conversations, according to an embodiment of the present disclosure. In some embodiments, the sentiment evaluation module 108 of FIG. 1 can be implemented with the example sentiment evaluation module 252. As shown in the example of FIG. 2, the example sentiment evaluation 252 can include a data input module 254 and a scale score module 256.

The sentiment evaluation module 252 can apply a trained machine learning model to determine sentiments associated with conversations. As described above, a machine learning model can be trained based on training data relating to conversation between users and agents of entities. The machine learning model can accept features associated with a conversation of a user and other relevant features as input. Based on the input, the machine learning model can output a sentiment score and/or a sentiment label associated with the conversation. Applying the machine learning model to predict a sentiment score and/or a sentiment label for a conversation is explained further below.

The data input module 254 can obtain various features associated with a conversation and a user associated with the conversation. For example, if the machine learning model is being applied to a conversation of a user, relevant features can be obtained and provided as input to the machine learning model. Features provided as input to the machine learning model can include attributes associated with the conversation, attributes associated with demographic characteristics of the user, attributes associated with post history of the user, attributes associated with page history of the user, etc. The attributes associated with the conversation, the attributes associated with the demographic characteristics of the user, the attributes associated with the post history of the user, and attributes associated with the page history of the user can be similar to attributes associated with conversations, attributes associated with demographics of users, attributes associated with post history of users, and attributes associated with page history of users, as explained above. As an example, as explained above, the attributes associated with the conversation can include sentiment scores for utterances of the conversation, and the sentiment scores for the utterances of the conversation can be provided as input to the machine learning model. The sentiments scores for the utterances of the conversation can indicate respective sentiment scores for the utterances of the conversation. For example, the sentiment scores for the utterances can be in the form of a sequence of scores. The sentiment scores for the utterances can include sentiment scores determined by the conversation analysis module 104 as described above. Based on the provided input, the machine learning model can output a sentiment score associated with the conversation.

The scale score module 256 can convert a sentiment score associated with a conversation from the machine learning model to a rating on a rating scale. For example, the rating scale can be a 5-point Likert scale, and the rating scale can include ratings of “poor,” “fair,” “average,” “good,” and “excellent.” A range of values of the sentiment score can be associated with a rating of the rating scale. A sentiment score for a conversation can be converted to a rating on the rating scale based on the range of values of the sentiment score associated with a rating. A sentiment label corresponding to a rating can be assigned to a conversation. In some embodiments, the machine learning model can output a sentiment label instead of a sentiment score.

The sentiment evaluation module 252 can determine a sentiment score and a corresponding sentiment label for a conversation in or near real time as the conversation proceeds. The sentiment score and the sentiment label for a conversation can change over time. For example, a conversation can start out positive and become negative over time. Accordingly, the sentiment score and the sentiment label for the conversation can be determined as the conversation proceeds. For example, the sentiment evaluation module 252 can determine a sentiment score and a sentiment label for the conversation based on utterances and information up to a current point in time. In this way, the sentiment evaluation module 252 may classify conversations associated with users according to appropriate sentiment labels. In some embodiments, the sentiment evaluation module 252 can only determine a sentiment score without determining a corresponding sentiment label for the sentiment score.

Sentiment scores and/or sentiment labels associated with conversations can have various applications. As an example, changes in sentiment scores and/or sentiment labels for conversations can be monitored, and various actions can be taken based on the changes. For instance, if a conversation between a user and an agent becomes negative and stays negative for a period of time, an agent that is more experienced can step in for the conversation or provide tips to the agent. Monitoring can include determining whether a rating of a conversation satisfies a threshold value. For example, it can be determined whether a rating of a conversation falls below a threshold rating (e.g., “fair” rating). Monitoring can also include determining whether an amount of time associated with a rating of a conversation satisfies a threshold value. For example, it can be determined whether an amount of time associated with a rating of a conversation exceeds a threshold amount of time. The threshold amount of time can be specified in units of time (e.g., seconds, minutes, etc.). As an example, most recent utterances associated with a rating can be considered. Monitoring can further include determining whether a number of utterances associated with a rating satisfies a threshold value. For example, instead of or in addition to determining an amount of time associated with a rating of a conversation, it can be determined whether a number of utterances associated with a rating exceeds a threshold number. As an example, most recent utterances associated with a rating can be considered. Actions to be taken based on monitoring can be specified. For example, notifications or alerts can be sent to agents or other entities regarding conversations that may require special actions. In some embodiments, agents can be automated agents, and a human agent can step in for a conversation if a special action is required.

In certain embodiments, sentiments associated with utterances of agents can be determined. For example, sentiments associated with utterances of agents can be determined, in addition to sentiments associated with utterances of users. Sentiment scores for utterances of agents can be determined in a similar manner as explained above. In some embodiments, agents can be automated agents. For instance, automated agents can be based on artificial intelligence, machine learning techniques, etc. Automated agents can be trained based on sentiments associated with utterances of agents. Automated agents may engage in a conversation with a user, for example, relating to general questions, customer service, etc.

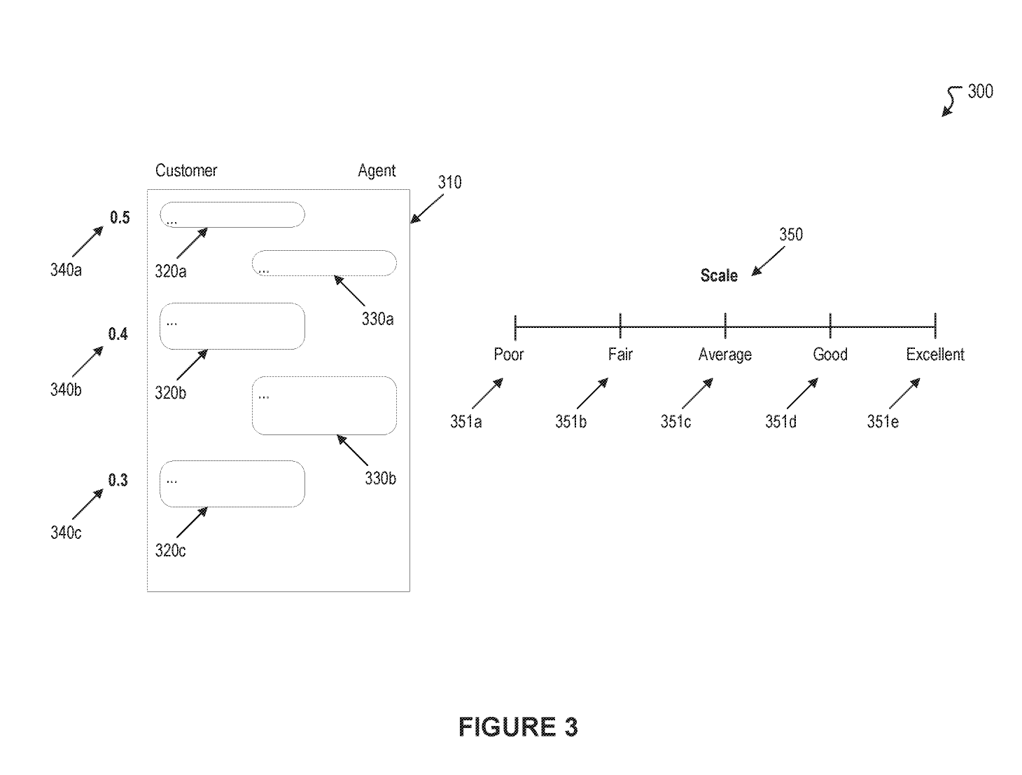

FIG. 3 illustrates an example scenario 300 for determining sentiments associated with conversations, according to an embodiment of the present disclosure. The example scenario 300 illustrates an example of a chat conversation 310 (e.g., as presented in a chat window). The conversation 310 can include one or more utterances by a customer and one or more utterances by an agent. For example, the utterances of the customer appear on the left side, and the utterances of the agent appear on the right side. The conversation 310 includes user utterances 320a, 320b, and 320c. The conversation 310 includes agent utterances 330a and 330b. Each utterance can include content. In the example scenario 300, content in the user utterances 320a, 320b, 320c and the agent utterances 330a, 330b is shown as ellipses for illustrative purposes, but an utterance can include any type of content, such as text, emoticon, emoji, etc. A user utterance 320 can be analyzed to determine a sentiment score associated with the user utterance 320. For example, the user utterance 320a has a sentiment score 340a of 0.5, the user utterance 320b has a sentiment score 340b of 0.4, and the user utterance 320c has a sentiment score 340c of 0.3. The sentiment scores 340 for the user utterances 320 can be provided as input to a machine learning model in order to determine a sentiment associated with the conversation 310.

A sentiment associated with the conversation 310 can be provided as a rating on a rating scale 350. The rating scale 350 includes 5 ratings 351: “poor” 351a, “fair” 351b, “average” 351c, “good” 351d, and “excellent” 351e. The ratings 351 can be associated with corresponding sentiment labels, and the conversation 310 can be assigned a sentiment label associated with a rating 351. In some embodiments, the ratings 351 can be numerical values, and corresponding sentiment labels can include text expressions associated with numerical values. For example, the ratings 351 can represent numerical values from 1 to 5. A value of 1 can correspond to “poor,” a value of 2 can correspond to “fair,” and so forth. In other embodiments, the ratings 351 and sentiment labels can be the same. For example, the “poor” rating 351a is assigned a “poor” sentiment label.

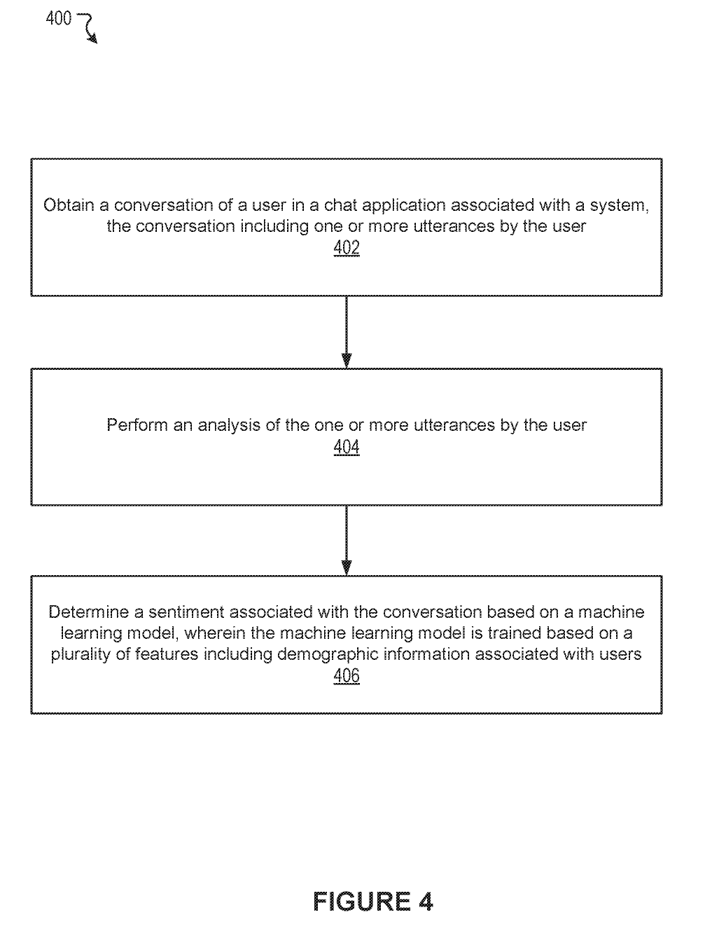

FIG. 4 illustrates an example first method 400 for determining sentiments associated with conversations, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can obtain a conversation of a user in a chat application associated with a system, the conversation including one or more utterances by the user. At block 404, the example method 400 can perform an analysis of the one or more utterances by the user. At block 406, the example method 400 can determine a sentiment associated with the conversation based on a machine learning model, wherein the machine learning model is trained based on a plurality of features including demographic information associated with users. Other suitable techniques that incorporate various features and embodiments of the present disclosure are possible.

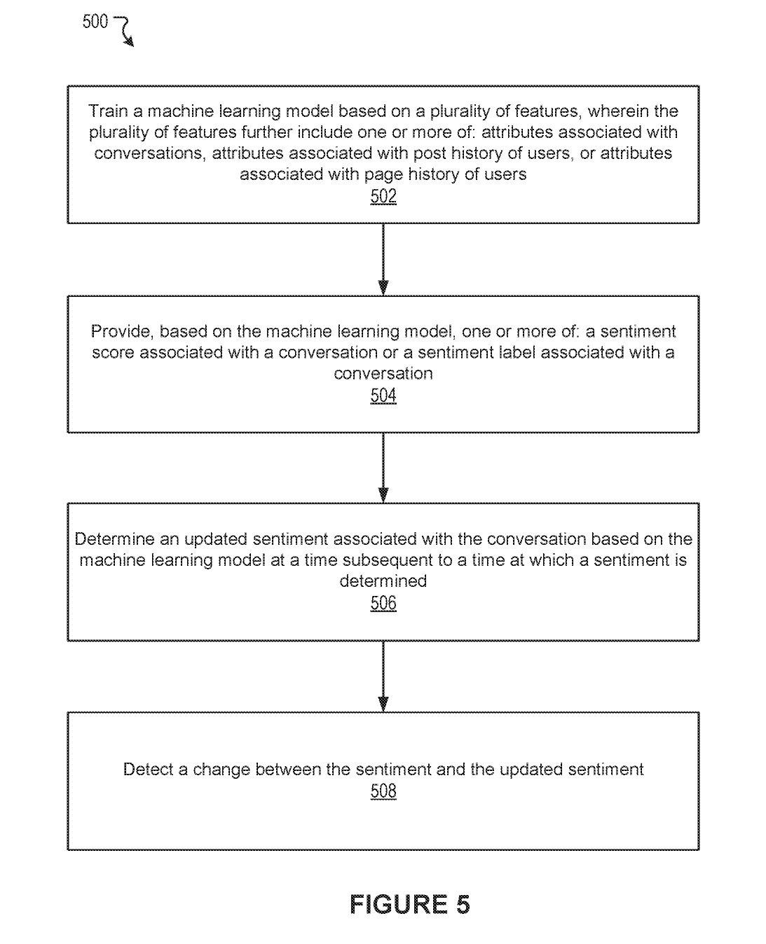

FIG. 5 illustrates an example second method 500 for determining sentiments associated with conversations, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can train a machine learning model based on a plurality of features, wherein the plurality of features further include one or more of: attributes associated with conversations, attributes associated with post history of users, or attributes associated with page history of users. The machine learning model can be similar to the machine learning model explained in connection with FIG. 4. The plurality of features can be similar to the plurality of features explained in connection with FIG. 4. At block 504, the example method 500 can provide, based on the machine learning model, one or more of: a sentiment score associated with a conversation or a sentiment label associated with a conversation. The conversation can be similar to the conversation explained in connection with FIG. 4. At block 506, the example method 500 can determine an updated sentiment associated with the conversation based on the machine learning model at a time subsequent to a time at which a sentiment is determined. The sentiment can be similar to the sentiment explained in connection with FIG. 4. At block 508, the example method 500 can detect a change between the sentiment and the updated sentiment. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a sentiment score module 646. The sentiment score module 646 can be implemented with the sentiment score module 102, as discussed in more detail herein. In some embodiments, one or more functionalities of the sentiment score module 646 can be implemented in the user device 610.

### Hardware Implementation

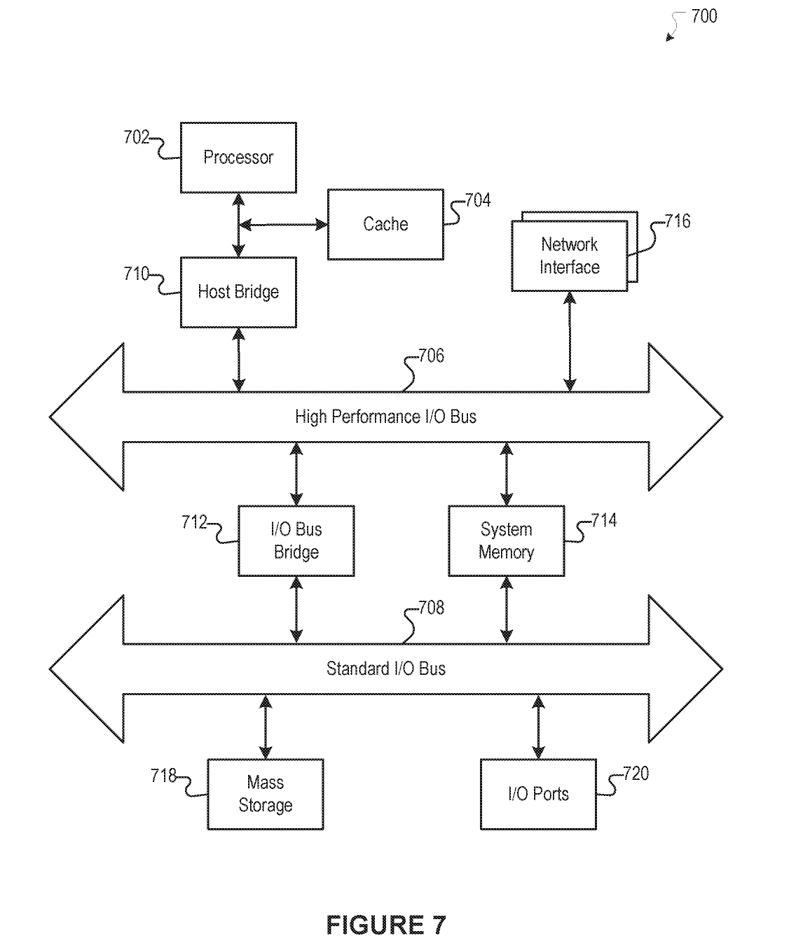

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
obtaining, by a computing system, a conversation of a user in a chat application associated with a system, the conversation including one or more utterances by the user;
performing, by the computing system, an analysis of the one or more utterances by the user; and
determining, by the computing system, a sentiment associated with the conversation based on a machine learning model, wherein the machine learning model is trained based on a plurality of features including demographic information associated with users.

2. The computer-implemented method of claim 1, wherein the system is a social networking system, and the conversation is between the user and an agent associated with a page of an entity in the social networking system.

3. The computer-implemented method of claim 1, further comprising training the machine learning model based on the plurality of features, wherein the plurality of features further include one or more of: attributes associated with conversations, attributes associated with post history of users, or attributes associated with page history of users.

4. The computer-implemented method of claim 1, wherein the machine learning model provides one or more of: a sentiment score associated with the conversation or a sentiment label associated with the conversation.

5. The computer-implemented method of claim 4, wherein the sentiment label is indicative of a rating on a rating scale.

6. The computer-implemented method of claim 1, wherein the sentiment associated with the conversation is determined in or near real time.

7. The computer-implemented method of claim 1, wherein the performing the analysis of the one or more utterances by the user includes performing a textual analysis of an utterance by the user.

8. The computer-implemented method of claim 1, wherein the performing the analysis of the one or more utterances by the user includes determining a sentiment associated with one or more of: an emoticon, an emoji, or an indicator relating to text style.

9. The computer-implemented method of claim 1, wherein the sentiment associated with the conversation is determined based at least in part on the analysis of the one or more utterances by the user.

10. The computer-implemented method of claim 1, further comprising:
determining an updated sentiment associated with the conversation based on the machine learning model at a time subsequent to a time at which the sentiment is determined; and
detecting a change between the sentiment and the updated sentiment.

11. A system comprising:
at least one hardware processor; and
a memory storing instructions that, when executed by the at least one processor, cause the system to perform:
obtaining a conversation of a user in a chat application associated with a system, the conversation including one or more utterances by the user;
performing an analysis of the one or more utterances by the user; and
determining a sentiment associated with the conversation based on a machine learning model, wherein the machine learning model is trained based on a plurality of features including demographic information associated with users.

12. The system of claim 11, wherein the instructions further cause the system to perform training the machine learning model based on the plurality of features, wherein the plurality of features further include one or more of: attributes associated with conversations, attributes associated with post history of users, or attributes associated with page history of users.

13. The system of claim 11, wherein the machine learning model provides one or more of: a sentiment score associated with the conversation or a sentiment label associated with the conversation.

14. The system of claim 11, wherein the sentiment associated with the conversation is determined in or near real time.

15. The system of claim 11, wherein the sentiment associated with the conversation is determined based at least in part on the analysis of the one or more utterances by the user.

16. A non-transitory computer readable medium including instructions that, when executed by at least one hardware processor of a computing system, cause the computing system to perform a method comprising:
obtaining a conversation of a user in a chat application associated with a system, the conversation including one or more utterances by the user;
performing an analysis of the one or more utterances by the user; and
determining a sentiment associated with the conversation based on a machine learning model, wherein the machine learning model is trained based on a plurality of features including demographic information associated with users.

17. The non-transitory computer readable medium of claim 16, wherein the method further comprises training the machine learning model based on the plurality of features, wherein the plurality of features further include one or more of: attributes associated with conversations, attributes associated with post history of users, or attributes associated with page history of users.

18. The non-transitory computer readable medium of claim 16, wherein the machine learning model provides one or more of: a sentiment score associated with the conversation or a sentiment label associated with the conversation.

19. The non-transitory computer readable medium of claim 16, wherein the sentiment associated with the conversation is determined in or near real time.

20. The non-transitory computer readable medium of claim 16, wherein the sentiment associated with the conversation is determined based at least in part on the analysis of the one or more utterances by the user.
